(19) United States
(12) Patent Application Publication
(10) Pub. No.: US 2014/0272889 A1
(43) Pub. Date: Sep. 18, 2014

(54) COMPUTER IMPLEMENTED LEARNING SYSTEM AND METHODS OF USE THEREOF

(71) Applicant: CAREER EDUCATION CENTER, Schaumburg, IL (US)

(72) Inventors: Manoj Kulkarni, Arlington Heights, IL (US); Chandrashekar Jois, Streamwood, IL (US); Ryan Sorensen, Arlington Heights, IL (US); Justin Watkins, North Aurora, IL (US); Judith Komar, Lake in the Hills, IL (US); Jason Vanecko, Schaumburg, IL (US); Candice Suriano, Riverside, IL (US)

(73) Assignee: Career Education Center, Schaumburg, IL (US)

(21) Appl. No.: 13/837,972

(22) Filed: Mar. 15, 2013

(51) Int. Cl. G09B 5/08

(52) U.S. Cl. CPC G09B 5/08
USPC 434/350

(57) ABSTRACT

A learning system including an information bus, a student information system, a content repository, a learning content management system, and a learning engine is provided. The student information system, the content repository, the learning content management system, and the learning engine each publish messages to the information bus and subscribe to messages from the information bus. The learning system may present and track the efficacy of both learning map-based course materials and traditional course materials. Methods of using a learning system and creating course learning maps are also presented.

### BACKGROUND

Known computer-implemented learning systems have certain common characteristics. The common characteristics include a learning map and a learning engine. A learning map comprises course content segmented into learning nodes. Each learning node comprises a granular, measurable item of knowledge. The learning nodes are interconnected with each other. The interconnections reflect a path that a student may take from learning node to learning node to complete a particular course. The learning nodes do not necessarily align in a linear fashion. Several learning nodes may be equal-level prerequisite learning nodes for another learning node, and a given learning node may have more than one option for the next learning node.

A learning engine may be used to guide a student through a learning map. The learning engine may measure a student's performance on a given learning node, and may allow or deny a student to progress to the next learning node based on the student's current performance on the learning node.

There are certain disadvantageous characteristics of known computer-based learning systems. For example, typical adaptive learning systems exist as a separate application outside the rest of a school's curriculum. Student performance from more traditional-based coursework is not factored into the adaptive learning system. Accordingly, the total knowledge attainment of a student is not available to facilitate learning. Also, a student's performance in an adaptive learning environment is not readily transferable back to a more conventional learning environment.

In another example, once a pre-assessment is completed, there may be overly-rigid adherence to a learning map. Known systems have insufficient intelligence and/or flexibility to traverse the learning map to efficiently determine the knowledge attainment of a student and to make optimal recommendations as to a next step.

### SUMMARY

A learning system includes an information bus, a student information system, a learning content management system, a learning engine, a learning management system, and a learning analytics system. The information bus operates on a publish/subscribe model. The student information system may be configured to publish student information and class information on the information bus. The learning content management system may be configured to store sequential course content and to publish sequential course content to the information bus.

The learning engine may be configured to store learning map course content, to track student interaction with learning map course content, and to publish the learning map course content, next action recommendations, learning content recommendations, competency mastery and probability information, and learning map transactional data to the information bus. The learning map transactional data may comprise student interaction with learning map course content. The learning management system may be configured to subscribe to the sequential course content, the learning map course content, next action recommendations, class information and student information from the information bus, to present the sequential course content and the learning map course content to students, to track student interaction with sequential course content and to publish sequential transactional data to the information bus. The sequential transactional data may comprise student interaction with the sequential course content.

The learning analytics system may be configured to subscribe to the learning content recommendations and the competency mastery and probability information, sequential transactional data and learning map transactional data from the information bus, and to publish aggregated effectiveness patterns and probability information to the information bus.

In one example, the learning engine is further configured to subscribe to aggregated effectiveness patterns and probability information from the information bus. In another example, the learning content management system further comprises content authoring, content aggregation, and content publishing tools. The learning content management system may also be configured to subscribe to aggregated effectiveness patterns from the information bus.

The learning engine may further comprise a learning map engine and a recommendation engine, and the learning map engine is configured to subscribe to sequential course content and to generate a base learning map from the sequential course content.

In one aspect of the system, the learning map comprises a plurality of learning nodes, the learning nodes being grouped into objectives. The learning engine may be configured to publish a knowledge attainment metric and a competency accomplishment metric to the information bus for an objective. The learning management system may be further configured to subscribe to the knowledge attainment metric and the competency accomplishment metric, to determine a competency growth metric, to generate a composite metric based on the knowledge attainment metric, the competency accomplishment metric and the competency growth metric, and to apply a weighting factor to determine an initial objective grade at the time that an objective is first completed by a student.

In another example, the learning management system is further configured to determine a revised objective grade after an objective is revisited by a student. The learning management system may be configured to store the revised objective grade in a grade book in the learning management system. The composite metric may be expressed as a percentage, and the weighting factor may comprise a number of points assigned to an objective.

In another aspect of the invention, the learning content management system further comprises a sequential content repository and the learning engine further comprises a learning map repository. In another aspect of the invention, the learning engine further comprises a learning map engine, including a learning map repository, and a recommendation engine.

A method for presenting instructional materials is also provided. The method includes the steps of ingesting instructional materials into a learning map engine; conducting a gap analysis on a base learning map prepared by the learning map engine; and preparing a complete learning map from the base learning map and the gap analysis. Further steps include, from the complete learning map, creating a first course learning map including a first subset of learning nodes of the complete learning map; from the complete learning map, creating a second course learning map including a second subset of learning nodes of the complete learning map. Once the course learning maps are created, the method includes the step of individually presenting content associated with the first course learning map via computer interface to a plurality of students as the plurality of students traverse the first course learning map.

In another aspect of the invention, the method further includes the steps of determining an aggregated effectiveness of content associated with the first subset of learning nodes, modifying the content of at least one learning node into modified content, and determining an aggregated effectiveness of the modified content.

In another aspect, the method for presenting instructional materials further includes the steps of preparing sequential course content; individually presenting content associated with the sequential course content via computer interface to a plurality of students; determining an aggregated effectiveness of content associated with the sequential course content and of content associated with the first subset of learning nodes; and modifying the content of at least one of the sequential course content and the content associated with the first subset of learning nodes based on the aggregated effectiveness.

In another aspect, the method for presenting instructional materials further includes the steps of grouping learning nodes of the first course learning map into objectives; and generating an initial grade for an objective based on knowledge attainment, competency accomplishment, and competency growth at the time that a student completes the objective. The grade may be revised after a student revisits an objective to reflect an improvement in competency growth or other competency metric. In this example, competency growth reflects a difference between an initial competency state of the student and a current knowledge attainment of the student.

In another example, a method of guiding a student through a learning map based, computer-implemented educational course is provided. The method includes determining an initial competency state of the student; guiding the student to learning nodes within the learning map; tracking an identity of learning nodes with which the student interacts; and recording a length of time that the student interacts with learning nodes. The method further comprises determining a knowledge attainment of the student after interaction with learning nodes; generating a composite metric based on a knowledge attainment of the student, the identity of the learning nodes with which the student interacted, and the difference between the initial competency state and the knowledge attainment; generating a grade based on the composite metric and a number of points assigned to the learning node after a student visits a learning node; and revising the grade after the student revisits the learning node.

### DRAWINGS

FIG. 1 is a simplified block diagram of a learning system according to one example of the present invention.

FIG. 2 is a detailed block diagram of a learning system according to one example of the present invention.

FIG. 3 is an information flow diagram of a learning system according to one example of the present invention.

FIG. 4 is a flow chart for generating a learning map according to one example of the present invention.

FIG. 5 is an illustration of an example of a portion of a learning map according to one example of the present invention.

FIG. 6 is another illustration of an example of a portion of a learning map according to one example of the present invention.

FIG. 7 is an illustration of a class learning status screen according to one example of the present invention.

### DETAILED DESCRIPTION

Unless defined otherwise, all technical and scientific terms used herein have the same meaning as commonly understood by those of ordinary skill in the art to which the invention belongs. The articles “a” and “an” are used herein to refer to one or to more than one (i.e. to at least one) of the grammatical object of the article. By way of example, “an element” refers to one element or more than one element. Throughout this specification, unless the context requires otherwise, the words “comprise”, “comprises” and “comprising” will be understood to imply the inclusion of a stated step or element or group of steps or elements, but not the exclusion of any other step or element or group of steps or elements.

Referring to FIG. 1, a learning system 10 according to one example of the invention comprises a Learning Management System (LMS) 12, a Learning Content Management System (LCMS) 14, a Learning Engine 16, Student Information System 18, Learning Analytics 20 and an Information Bus 22. The LMS 12, LCMS 14, Learning Engine 16, Learning Analytics 20 and Student Information System 18 publish information to the Information Bus 22, subscribe to information from the Information Bus 22, or both. The Learning System 10 may comprise a complete, integrated adaptive learning environment.

The Information Bus 22 may comprise a commercially available enterprise service bus. In one preferred embodiment, the Information Bus 22 employs a publish/subscribe architecture, where entities may publish messages to the Information Bus 22, which then routes the messages to one or more subscribers. In one example, messages communicated by the Information Bus 22 may be implemented through the XML documents and defined with the XML schemas in XSD standard. In another example, the messages may comprise software objects as defined by a class.

In another example, the Information Bus 22 may transform certain messages to another format before routing the messages to subscribers. In this regard, the Information Bus 22 may include transformation maps for transforming one message type to another. The Information Bus 22 may further comprise a database, such as an SQL database, to store the messages until an event indicates that a message is to be delivered.

A more detailed block diagram is provided in FIG. 2. For clarity, this figure omits information flow arrows. In this example, the Learning Management System (LMS) may be implemented within a Student Portal 30, which may comprise a portal framework comprising a web application platform or other suitable framework accessible by use of an Internet browser. The Student Portal 30 may be accessible by via an intranet or the Internet. Other suitable frameworks are available. The LMS 12 may comprise a Content Viewer 31, Content Management 32, Activity Tracking 33, Competency Tracking 34, Grade Book 35, Equation Editor 36, Assessment Engine 37, and Student Forums 38.

The Learning Content Management System (LCMS) 14 may be implemented within a Staff Portal 40, which may also be implemented with a portal framework comprising a web application platform or other suitable framework. The LCMS 14 may comprise Content Authoring 41, Content Aggregation 42, Content Publishing 43, Objectives Management 44, Course Management 45 and Content Repository 46.

The Learning Engine 16 may be based on any suitable commercially available adaptive learning engine. In one example, the Learning Engine 16 comprises a Learning Map Engine 50 and a Recommendation Engine 52. The Learning Map Engine 50 and the Recommendation Engine 52 may be combined in a single entity or implemented separately. The Recommendation Engine 52 may receive information from CEP 55 (Complex Event Processing), Rules Engine 56, and Pedagogy/Configuration 57 modules.

The Learning System 10 also includes the Student Information System 18. The Student Information System 18 may comprise a database that is configured to store student records. A student information service may be implemented as an access layer to provide access to the information stored in the Student Information System 18.

Referring to FIG. 3, a high-level logical information flow is illustrated. The Information Bus 22 is not shown, but it handles the messaging to achieve the information flow as shown. After Pre-Assessment 70, a student may access the Student Learning 71 for a particular class or assignment or objective within a class. Pre-Assessment 70 is a process to determine an initial competency state. Information from the Student Learning 71 process is provided to Learning Analytics 20 and the Recommendation Engine 52. Access 79 information is also provided to the Recommendation Engine 52. The Recommendation Engine 52 is also provided information concerning School Policies 77 and Configuration Information 76. Learning Analytics 20 provides information to the Recommendation Engine 52 and to Content Engineering 72. Content Engineering 72 is a process for authoring, aggregating, and publishing content. Content may be stored in Content Repository 46. Student Learning 71 receives information from Content Repository 46, as determined by Pedagogy 74. The process flow concludes with student Learning Outcome 78.

In the Learning Content Management System 14, with respect to Content Engineering 72, Content Authoring 41 and Content Aggregation 42 provide tools for course content preparation. Generally, traditional sequential content, including complete courses, may be stored in the Content Repository 46. “Sequential” content refers to content that is presented in a pre-defined order, as in traditional syllabus-guided instruction. The Content Repository 46 may include textbooks, videos of classroom instruction, and kinetic instructional materials, such as animations and/or interactive programs. Once a course is prepared, Content Publishing 43 draws the course content from the Content Repository 46 and publishes it to the Learning Management System 12 so the students may view the content.

The Learning Map Engine 50 also includes a Learning Map Repository 54, in which learning maps may be stored. The Learning Map Engine may also provide tools for Content Engineering 72. A learning map is a course curriculum segmented into a set of learning objectives or skills that a student needs to obtain. These objectives or skills are mapped into learning nodes, and the learning nodes are connected to each other. A well-designed learning map facilitates self-paced learning and traversing of the learning map. The learning nodes of a learning map may be organized into objectives. The objectives may be linked back to a traditional course presentation/grading methodology. Objectives may also be referred to as units.

A learning node is completed when a learner achieves a pre-determined level of competency on the learning node. This can be achieved through, for example, trying a learning node successfully or completing a lesson successfully. A learning node is successfully tried or completed when a percentage of questions answered correctly on the learning node equals or exceeds a pass threshold. However, even if a student reaches the pass threshold, there may be additional room for improvement of competency with respect to the learning node.

A prerequisite network exists and students will be served prerequisite learning nodes required to be successful on the assigned learning nodes. The learning nodes are connected throughout the entire course map. Work on one learning node influences learning on other nodes in the course map. Learning is a continuum throughout the course.

Learning nodes are constructed in a learning map based on prerequisites. Students work their way through the learning map demonstrating achievement on the prerequisite learning nodes in order to move forward on the course map.

An objective is completed when all learning nodes in the objective have been completed and the overall standard for the objective is greater than or equal to a minimum objective standard. The minimum objective standard may be defined, for example, locally for an objective or at the grouping/class level. Once again, even if a student reaches the minimum objective standard, there may be additional room for improvement of competency with respect to the objective.

An example of a portion of a learning map is illustrated in FIG. 5. In this example, Punctuation Learning Map 150 is illustrated. On the left, Punctuation Learning Map 150 begins with Introduction to Punctuation 151. Introduction to Punctuation 151 is a prerequisite to four learning nodes: Introduction to Commas 152, Quotation Marks 156, End Punctuation 158, and Apostrophes 159. Introduction to Commas 152 is a prerequisite to Commas to Offset Nonrestrictive Elements 153, Colons and Semicolons 154, and Commas in Compound Sentences 155. Quotation Marks 156 is a prerequisite to Commas to Offset Direct Quotations 157. The Punctuation Learning Map 150 need not be followed in strict left-to-right order. If a student demonstrates mastery of a skill in a given learning node, it may not be necessary to direct the student to all of the learning nodes in the map.

An example of a Generic Learning Map 160 is illustrated in FIG. 6. In this example, there are 42 learning nodes. The Generic Learning Map 160 may be taught in two objectives or courses. The first objective may comprise learning nodes 1 through learning node 17. The second objective may comprise learning node 18 through learning node 42. The Generic Learning Map 160 illustrates a path between learning node 9 and learning node 14. In one example, if a student demonstrates mastery of the content in learning node 14, the student may skip learning node 4 through learning node 8 and proceed directly to learning node 9. In another example, if student activity in learning node 9 reveals a deficiency in knowledge attainment, the student may be directed back to learning node 14.

In general, a student will select an objective and work through the learning that it defines. However the learning system 10 may direct a student to another objective. When an objective is completed the system may direct a student to the objectives that build upon the knowledge of the current objective; if there are none then the student may be directed to other objectives that contain “open” learning nodes. Students may work on various objectives at one time, achieving multiple learning nodes and fulfilling multiple prerequisites. Also, a learning map need not always be traversed in one direction. For example, referring to FIG. 6, during an assessment phase, a student may be started on learning node 4, and then directed back to learning node 2 or forward to learning node 5 depending upon performance with respect to learning node 4.

The present invention may associate more than one modality of content for any given learning node. For example, a learning node concerning solving quadratic equations may include the following modalities: textbook materials, interactive examples, animations, and videos of classroom instruction. The Learning Engine 16 may identify a preferred learning modality on a student-by-student basis and direct the student to the most effective modality of course content.

Content Engineering 72 comprises the processes of content authoring, content design, content integration, content authorization and content programming. In one aspect, Content Engineering 72 comprises, in part, the task of converting instructional materials, including but not limited to sequential course content, into a node-based learning map. The node-based learning map may then be used in an adaptive learning environment. Content Engineering 72 assists in the production of optimized learning maps. The quality of the learning process depends in large part on the granularization of course content into learning nodes, and linking of the learning nodes into a learning map. Content Engineering 72 may involve processes in the Learning Map Engine 50, such as creation of a base learning map and additional processes, such as learning map refinement, content analysis, and content modification.

Referring to FIG. 4, a method of presenting course materials 100 is illustrated. In step 110 instructional materials, such as text books and other course materials, are formatted in XML (Extensible Markup Language). In step 112, the XML-formatted content is ingested into the Learning Map Engine 50, which produces a base learning map. The instructional materials to be ingested may also include not only course content, but prerequisite content and desired outcome-based content. Prerequisite content facilitates knowledge state assessment at beginning of course.

Preferably, the content is granular. In map based learning, a student starts in the middle of the map, and depending on whether skills/knowledge are confirmed at the first tested learning node, the student may be moved ahead or back in the learning map. By traversing a map intelligently based on answers given, a skills/knowledge inventory of the student may be constructed. This depends on having the appropriate learning nodes and level of granularity.

In step 114, the base learning map may be returned to tools associated with the process of Content Engineering 72, such as Content Authoring 41, Content Aggregation 42, and Content Publishing 43. In step 116, a “gap analysis” is performed. The gap analysis is to ensure that the entire content of the course is covered in the learning map. Gap analysis also involves ensuring appropriate detail of coverage. For example, if three questions exist for one item of information and ten questions exist for another, it may be preferable to re-balance the questions. In step 118, the complete learning map is authored based on the base map and the gap analysis.

In a preferred embodiment, learning maps are designed to be useful across course boundaries and school boundaries. For example, an English Composition learning map may include everything about English composition. One school creating a general English composition course may use a large portion of the map. However, another school (e.g., culinary) may use a much smaller portion of the learning map that is relevant to the culinary school's course. In another example, a school of business may include nodes from a general mathematics map to assist students with statistical analyses.

Accordingly, in FIG. 4, the method includes steps for creating and presenting more than one course from the same complete learning map. In step 120, a first course learning map is created. In step 122, the content from the first course learning map is presented to students. In step 124, student interaction is tracked. In step 126, aggregated effectiveness of the content is determined. In step 128, the content may be modified based on the aggregated effectiveness as determined in step 126. The method also includes step 130, which is creating a second course learning map from the complete learning map. In step 132, the content from the second course learning map is presented to students. As indicated by the arrow from step 128 to step 132, the content presented in the second course learning map may include modifications to content as made with respect to the first course learning map. In step 134, student interaction is tracked. In step 136, aggregated effectiveness of the content is determined. In step 138, the content may be modified based on the aggregated effectiveness as determined in step 136.

Regarding the steps for determining aggregated effectiveness 126, 136, and for modifying content 128, 138, as set forth in more detail below, tools associated with the process of Content Engineering 72 subscribe to Aggregated Effectiveness information from Learning Analytics 20. Aggregated Effectiveness information allows Content Engineering 72 to flag content that may require improvement, such as questions that have an undesirable level of incorrect answers or correct answers, or content where student activity indicates very little time invested or an inordinate amount of time invested.

The LMS provides, as noted above, at least a Content Viewer 31 and Activity Tracking 33. Preferably, the student is not switched to a separate learning application—the adaptive Learning System 10 is integrated into the learning environment for the teaching institution. Accordingly, the Content Viewer 31 and Activity Tracking 33 may be configured for both conventional course content and learning map content.

When a course presented in a traditional sequential format is accessed, the Content Viewer 31 subscribes to information from the Content Repository 46. When a course is presented with learning map content is accessed, Content Viewer 31 accesses information in the Learning Map Repository 54, and a student may be directed through a learning map according to Learning Content Recommendations from the Learning Map Engine 50. Activity Tracking 33 publishes student activities with respect to sequential course content, such as identification of course content access, a length of time the course content was accessed, and student performance with respect to questions, to Information Bus 22.

The Learning Engine 16 may similarly track student activity with respect to interactions with learning nodes and objectives of learning map content. The Learning Engine 16 may publish this learning map transactional data to the Information Bus 22.

The Recommendation Engine 52 uses student performance information from the Learning Map Engine 50, such as learning map transactional data comprising user interaction with learning map course content. The Recommendation Engine 52 provides Learning Content Recommendations and Competency mastery and probability information to the Learning Map Engine 50, and may also publish this information to the Information Bus 22. The Recommendation Engine 52 also subscribes to aggregated effectiveness patterns and probability information from Learning Analytics 20. The Recommendation Engine 52 also generates next action selection for the student. Next action selection may comprise evaluating the student's knowledge attainment determining what learning node or objective the student should study next. Learning Analytics 20 may also evaluate the student's competency and/or probability of success and provide that information to the Recommendation Engine 52. In this regard, the Recommendation Engine 52 provides a decision on what to do next, given the fact of the student's performance. The student may be advanced to the next topic. Alternatively, the student may be looped back to an earlier point in the learning map for remedial or additional instruction.

Learning Analytics 20 may be implemented as a data warehouse including a data mart as an access layer. The data warehouse may aggregate transactional student activity data into aggregated activity data, and store the aggregated activity data. Learning Analytics 20 may be configured to take a holistic approach, and aggregate student activity and competency over the career of the student. The data warehouse may further comprise business rules to process the aggregated student activity data as described below.

Learning Analytics 20 includes User Analytics 60 which, based on a student's past performance in the learning map, begins to profile the student and can predict with some accuracy future performance. One aspect of the learning system 10 is the capacity to determine the relationships that exist between items in the course content. This allows a predicted ability to be calculated at each item before it has been completed. This can be used to help both the student and system make informed decisions on their individual learning path.

With respect to Content Analytics 62, Learning Analytics 20 subscribes to student performance and knowledge-attainment information published by the Recommendation Engine 52, and publishes aggregated effectiveness patterns and probability to the Information Bus 22 and to the Recommendation Engine 52. Learning Analytics 20 also generates and publishes aggregated effectiveness information, which is subscribed to by the tools associated with Content Engineering 72. Learning Analytics 20 identifies questions and/or content where students consistently struggle with the subject matter. The content may be modified, modifying questions or interactive examples, such as by improving content, adding remedial information. Student feedback and learning map modifications are in real-time. Learning Analytics 20 may also identify content that is too easy, the questions may be modified or the learning map modified to drop the learning node. Factors in assessing questions include whether question had more correct than incorrect answers, the amount of time spent answering a question, and whether the questions scaffold the students through the content network.

Learning Analytics 20 can close the loop on modified content. After modification, Learning Analytics 20 publishes updated aggregated effectiveness patterns, and any improvements in content quality can be measured. Successive iterations of modifications and measurement of effectiveness may continue to improve content.

Learning Analytics 20 publishes information regarding student performance. For example, Learning Analytics 20 can detect and publish information indicating that a given individual student has difficulty learning a subject, or other student learning factors on a student-by-student basis. The Recommendation Engine 52 may subscribe to this information. This may improve the next action selection by the Recommendation Engine. One may build results from a population and apply it to individuals, or take results from one student and extrapolate that result to other students.

Learning Analytics may also include Reporting 64. Reporting 64 aids in documenting compliance with accreditation requirements.

In one example of a method for determining a preferred modality, the system presents a first modality of content to a student and a second modality of content to the student. The system then determines a preferred modality of content for the student. A rate of learning accomplishment, or a mastery of the content, or some of the two metrics may be used to determine a preferred modality. A combination is preferred because when the student is successful with a modality, it helps the student master the content and then that raises the learning accomplishment. If the preferred modality is the first modality, then the system continues to present the first modality of content to the student, and to monitor effectiveness. If the preferred modality is the second modality, then the system continues to present the second modality of content to the student, and to monitor effectiveness.

The Learning Map Engine 50 receives Learning Content Recommendations and Competency mastery and Probability information from the Recommendation Engine 52. The Learning Map Engine 50 further subscribes to information from the Student Information System 18, including student information and course/class information. The Learning Map Engine 50 publishes learning map transactional data comprising student interaction with learning map course content, grades/scores generated by the Learning Engine 16, student skills assessments, and student outcome mastery assessments.

In one aspect of the present invention, progressive grading may be applied to student learning performance. One issue with node-based learning, where learning is not necessarily linear or lock-step in time, is how to score an individual's performance in a way that is compatible with traditional models of grading. In this respect, one goal of the present system is competency-based learning. The system can measure skills achievement and knowledge attainment with a level of specificity that is not reflected by the traditional method of issuing grades at the end of a class.

In one example, a student may complete an objective or node with sufficient proficiency to be allowed to move on to another learning node. A level of knowledge attainment may be determined for the student at the time that the node was completed, or, in the alternative, as of a given due-date for the node. If, however, Recommendation Engine 52 and/or Learning Analytics 20 subsequently determine that the student's knowledge attainment with respect to the subject matter of the learning node is no longer sufficient, the Recommendation Engine 52 may return the student to the learning node to re-learn the subject matter. In another example, faculty may assign a student to revisit a learning node or objective. Alternatively, a student may decide on his or her own to revisit a learning node for practice and/or further mastering.

During this loop-back, the student may earn an improved assessment regarding achievement with respect to that objective or node. Progressive grading allows the student to improve an objective grade if subsequent assessments show an improvement in achievement.

For example, English composition may have two objectives, objective 1 comprising narrative writing, and objective 2 comprising persuasive writing. In a traditional course, once objective 1 was completed, the grade would be entered, and the entire class would move on to objective 2 as a group. In node-based learning, however, the system may recommend that a given student return to a learning node from objective 1 for a refresher or to re-enforce a concept. In doing so, the student may improve his or her knowledge attainment and demonstrate additional effort to master the course objectives.

In progressive grading, at the end of an objective, a “marker” is set for the grade. The marker comprises a composite grade as it exists at that point in time. The point in time may be a due-date for completing an objective of the course. In one example, the Learning Engine 16 provides raw information comprising metrics such as: 1) knowledge attainment, 2) competency accomplished, and 3) an improvement score. The “knowledge attainment” metric may comprise the number of learning nodes where evidence exists that the student has ability. The ability may be expressed as a percentage. The “competency accomplished” metric may comprise the number of nodes completed as a proportion of the total number of nodes. The “improvement score” may involve a number of learning nodes that were revised, a number of learning node practice operations, and a number of overall practice operations.

In one example, the Learning Engine 16 publishes knowledge attainment, competency accomplished, and improvement score information to the Information Bus 22, and the LMS 12 subscribes to the information. LMS 12 further processes the metrics to determine competency growth. Competency growth is the delta between original knowledge state and knowledge attainment after an objective or learning node is completed. Original knowledge state may be determined in student assessment at beginning of each objective. Competency growth score may be one of the components of an objective and/or final course grade. In an alternative example, the Learning Engine 16 or Learning Analytics 20 may determine competency growth.

In one embodiment, the LMS then computes a grade based on the metrics provided by the Learning Engine 16, weighted for objective content. In this example, a composite metric is generated. The knowledge attainment metric comprises 40% of the composite metric, the competency accomplished metric comprises 50% of the composite metric, and the competency growth metric comprises 10% of the composite metric. The LMS 12 may the multiply the composite metric by a number of points for the objective to generate an objective grade, and then store the objective grade in Grade Book 35.

As a student revisits and improves performance on learning nodes, the raw information measured by the Learning Engine 16 changes, as does the competency growth metric. Objective grades may be revised accordingly, even though the objective has been completed. The grading page may show both the objective grade achieved as of the due-date for an objective, and current objective grade that has been revised to reflect improved competency after the objective was initially completed.

The Learning System 10 transparently supports both traditional coursework and adaptive learning coursework. Courses may have traditional content, node-based content, or a combination. Adaptive learning may be set up on an “assignment” basis. This may be used to set up a “smart path” through the course. Students who learn well in an adaptive learning environment may select the adaptive learning path, while other students may opt for more traditional learning paths. Past student performance may be used to identify those students who are well-suited to adaptive learning techniques. Information from traditional courses may be used as input to guide selection of next node on a node-based learning map.

A learning map may be deployed graphically. In one example, the learning system 10 adds information to a learning map relating to an individual student or a group of students, such as a class.

An individual student may view a learning node or a series of learning nodes and their relationships to each other. The Learning System 10 may change the node to reflect the student's knowledge attainment with respect to the specific node. For example, the student will be directed to a learning node if there is no confirmation of knowledge, or may be directed to another previous learning node that indicates inadequate knowledge attainment, to a confirmation that there is sufficient knowledge attainment for the learning node. The learning node may also be annotated to indicate a recommended next learning node for a student to address.

Faculty may also track student performance. Faculty may view similar information with respect to individual, students, and also view aggregated knowledge attainments and knowledge accomplished for a group of students, such as a class. Based on this information, the instructor can employ adaptive instructional strategies.

In one example illustrated in FIG. 7, the Learning System 10 may be configured to display a Current Student Data Screen 190. The Current Student Data Screen 190 may include a list of students, the current knowledge attainment of each student, the knowledge accomplished by each student, cumulative work time, and estimated time remaining to complete the objective. The Learning System 10 may estimate the time remaining to completion based on a student's past rate of learning, and current knowledge attainment, and other factors.

In a preferred aspect of the invention, the Current Student Data Screen 190 is updated periodically or even continuously, so that the Current Student Data Screen 190 provides an up to the moment assessment of student competency achievement. A view to this data may be provided by the Learning Engine 16.

Based on current performance for an objective the students of a class may be grouped into categories, including: 1) students who are performing with a low degree of competency, and 2) students who are performing with a high degree of competency. It may be that a given student does not fall into either category. Student learning status is updated periodically, or preferably, continuously in real time. The system may also group learning nodes into categories, including 1) items where students have a low degree of success, and 2) items where students have a high degree of success. Information relevant to categorizing learning status may include student abilities, lesson time, average score, student errors, and number of times the lesson is activated. The instructor may choose to spend more class time on items where success is low, and less time on items where a high degree of success is indicated. Class learning status is updated continuously in real time.

As an individual student's information regarding knowledge attainment is updated, estimates of success on uncompleted nodes are also updated, and reconsiderations for a path for the student to traverse the learning map are also updated. The Learning System 10 may dynamically adjust the learning path to accelerate learning with real-time feedback.

The Learning System 10 may be configured to measure and report growth of knowledge over time. When an objective or course is started, a knowledge assessment may be conducted to determine an initial knowledge state. As the student progresses through the learning map or other course materials, knowledge attainment may be updated, and growth in knowledge attainment over time may be displayed.

Learning may be individualized. The tracking of an individual student's knowledge attainment also reveals “holes” in the individual student's knowledge. Each student may have different holes. The Recommendation Engine 52 and Learning Analytics 20 may direct the student to address individual holes.

Classroom learning may be improved. Faculty will have knowledge concerning where the class as a group has a knowledge deficiency. The classroom teaching may be optimized to address those subjects which would benefit most students. Topics that are well-mastered by the class as a group may be skipped (avoid attrition due to boredom).

The various examples of learning systems and components and processes of learning systems described herein and/or shown in the drawings are presented by way of example only and are not limiting as to the scope of the invention. Unless otherwise specifically stated, individual aspects and components of the hybrids may be modified, or may have been substituted therefore known equivalents, or as yet unknown substitutes such as may be developed in the future or such as may be found to be acceptable substitutes in the future.

What is claimed is:

1. A learning system, comprising:
a. an information bus;
b. a student information system configured to publish student information and class information on the information bus;
c. a learning content management system configured to store sequential course content and to publish sequential course content to the information bus;
d. a learning engine configured to store learning map course content, to track student interaction with learning map course content, and to publish the learning map course content, next action recommendations, learning content recommendations, competency mastery and probability information, and learning map transactional data to the information bus, the learning map transactional data comprising student interaction with learning map course content;
e. a learning management system configured to subscribe to the sequential course content, the learning map course content, next action recommendations, class information and student information from the information bus, to present the sequential course content and the learning map course content to students, to track student interaction with sequential course content and to publish sequential transactional data to the information bus, the sequential transactional data comprising student interaction with the sequential course content; and
f. a learning analytics system configured to subscribe to the learning content recommendations and the competency mastery and probability information, sequential transactional data and learning map transactional data from the information bus, and to publish aggregated effectiveness patterns and probability information to the information bus.

2. The learning system of claim 1, wherein the learning engine is further configured to subscribe to aggregated effectiveness patterns and probability information from the information bus.

3. The learning system of claim 1, wherein the learning content management system further comprises content authoring, content aggregation, and content publishing tools.

4. The learning system of claim 3, wherein the learning content management system subscribes to aggregated effectiveness patterns from the information bus.

5. The learning system of claim 1, wherein the learning engine further comprises a learning map engine and a recommendation engine, and the learning map engine is configured to subscribe to sequential course content and to generate a base learning map from the sequential course content.

6. The learning system of claim 1, wherein the learning map comprises a plurality of learning nodes, the learning nodes being grouped into objectives, and the learning engine is configured to publish a knowledge attainment metric and a competency accomplishment metric to the information bus for an objective; wherein the learning management system is further configured to subscribe to the knowledge attainment metric and the competency accomplishment metric, to determine a competency growth metric, to generate a composite metric based on the knowledge attainment metric, the competency accomplishment metric and the competency growth metric, and to apply a weighting factor to determine an initial objective grade at the time that an objective is first completed by a student.

7. The learning system of claim 6, wherein the learning management system is further configured to determine a revised objective grade after an objective is revisited by a student.

8. The learning system of claim 7, wherein the learning management system is configured to store the revised objective grade in a grade book in the learning management system.

9. The learning system of claim 6, wherein the composite metric is expressed as a percentage, and the weighting factor comprises a number of points assigned to an objective.

10. The learning system of claim 1, wherein the learning content management system further comprises a sequential content repository and the learning engine further comprises a learning map repository.

11. The learning system of claim 1, wherein the learning engine further comprises a learning map engine, including a learning map repository, and a recommendation engine.

12. A method for presenting instructional materials, comprising:
a. ingesting instructional materials into a learning map engine;
b. conducting a gap analysis on a base learning map prepared by the learning map engine;
c. preparing a complete learning map from the base learning map and the gap analysis;
d. from the complete learning map, creating a first course learning map including a first subset of learning nodes of the complete learning map;
e. from the complete learning map, creating a second course learning map including a second subset of learning nodes of the complete learning map; and
f. individually presenting content associated with the first course learning map via computer interface to a plurality of students as the plurality of students traverse the first course learning map.

13. The method of claim 12, further comprising the steps of:
a. determining an aggregated effectiveness of content associated with the first subset of learning nodes;
b. modifying the content of at least one learning node into modified content; and
c. determining an aggregated effectiveness of the modified content.

14. The method of claim 12, further comprising the steps of:
a. preparing sequential course content;
b. individually presenting content associated with the sequential course content via computer interface to a plurality of students;
c. determining an aggregated effectiveness of content associated with the sequential course content and of content associated with the first subset of learning nodes;
d. modifying the content of at least one of the sequential course content and the content associated with the first subset of learning nodes based on the aggregated effectiveness.

15. The method of claim 14, further comprising:
a. grouping learning nodes of the first course learning map into objectives; and
b. generating an initial grade for an objective based on knowledge attainment, competency accomplishment, and competency growth at the time that a student completes the objective.

16. The method of claim 14, further comprising:
a. grouping learning nodes of the first course learning map into objectives;
b. generating an initial grade for an objective based on knowledge attainment, competency accomplishment, and competency growth at the time that a student completes the objective; and
c. generating a revised grade for the objective based on knowledge attainment, competency accomplishment, and competency growth at the time that the student revisits the objective.

17. The method of claim 16, wherein competency growth reflects a difference between an initial competency state of the student and a current knowledge attainment of the student.

18. A method of guiding a student through a learning map based, computer-implemented educational course, comprising:
a. determining an initial competency state of the student;
b. guiding the student to learning nodes within the learning map;
c. tracking an identity of learning nodes with which the student interacts;
d. recording a length of time that the student interacts with learning nodes;
e. determining a knowledge attainment of the student after interaction with learning nodes;
f. generating a composite metric based on a knowledge attainment of the student, the identity of the learning nodes with which the student interacted, and the difference between the initial competency state and the knowledge attainment;
g. generating a grade based on the composite metric and a number of points assigned to the learning node after a student visits a learning node; and
g. revising the grade after the student revisits the learning node.
